(19) United States
(12) Patent Application Publication
(10) Pub. No.: US 2008/0093899 A1
(43) Pub. Date: Apr. 24, 2008

(54) Motor Vehicle Seat

(75) Inventor: Gerd Stueckle, Hildrizhausen (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 10/591,641

(22) PCT Filed: Mar. 3, 2005
(86) PCT No.: PCT/EP05/02232

§ 371 Date: Jun. 12, 2007

(30) Foreign Application Priority Data
Mar. 6, 2004 (DE) 10 2004 011 089.1

(51) Int. Cl. B60N 2/42

(52) U.S. Cl. 297/216.1

(57) ABSTRACT

A motor vehicle seat has a seat height adjustment device for adjusting a first part of the motor vehicle seat in relation to a second part. At least one crash element is arranged between the first part and the second part, which in the event of a collision, prevents or at least hinders movement of the first part relative to the second part. According to the invention, the crash element comprises a piston-cylinder unit, with the piston being connected to the first part of the motor vehicle seat, and the cylinder connected to the second part. An opening is provided in a cylinder wall of the piston-cylinder unit through which a toothed blocking element can be engaged in a blocking manner with a toothing formed on the piston, at least in the event of a collision.

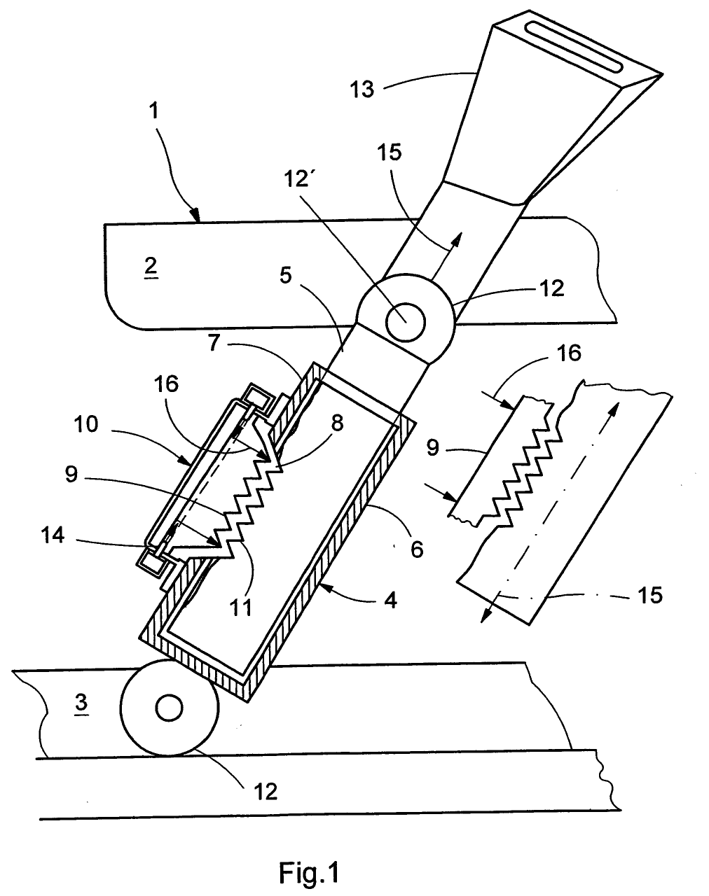

### BACKGROUND AND SUMMARY OF THE INVENTION

This application claims the priority of German patent document 10 2004 011 089.1, filed Mar. 6, 2004 (PCT International Application No. PCT/EP2005/002232, filed Mar. 3, 2005), the disclosure of which is expressly incorporated by reference herein.

The invention relates to a motor vehicle seat having a seat height adjustment.

During an accident, due to the abrupt deceleration, high inertia forces act on the vehicle occupants, the motor vehicle seat and the safety belt system which secures the vehicle occupants. In addition, the abrupt deceleration exerts upward, forward and/or rearward forces on a seat height adjustment device, which is often a weak point of the seat structure. There is thus the danger that the seat height adjustment device will become deformed and/or break, and consequently that the motor vehicle seat, and with it the vehicle occupants, will be shifted upward, forward or rearward, increasing the risk of injury, particularly to the head area.

A motor vehicle seat with a seat height adjustment device is disclosed in German patent document DE 103 16 341.7 (unpublished as of the priority date of this application). The seat height adjustment device serves to adjust a first part of the motor vehicle seat relative to a second part of the motor vehicle seat, with at least one crash element being arranged between the first and second parts. The crash element prevents or at least hinders relative movement of the first part with respect to the second part in the event of a collision, but permits height adjustments of the seat parts during normal operation. In this case, the first part is constructed, for example, as a seat rail, while the second part may be a top rail that is preferably adjustable in the longitudinal direction of the vehicle on the vehicle floor. In the event of a collision, the crash element prevents or hinders movement acting on the occupants of the vehicle due to inertia forces, and thus increases vehicle safety and a reduces the risk of injury.

German patent document DE 196 06 605 A1 discloses a vehicle, especially a convertible or coupe with low headroom, with at least one vehicle seat that is secured to the vehicle floor and supported by a floor element that is connected to and locked against the vehicle floor in a manner that permits an almost vertical relative movement. Furthermore, means are provided that, in the event of extreme vehicle deceleration (such as during an accident), release the locking and lower the floor element by lowering the vehicle seat through a cut-out in the vehicle floor and lock it in the lowered position. As a result, the entire vehicle seat is actively lowered below the level of the vehicle floor, and extended headroom is thus provided in the roof area. A strapped-in seat user can thus not come into contact with structural parts of the roof despite shifting of his or her head forwards or backwards by the collision.

German patent document DE 101 07 695 A1 discloses a motor vehicle seat with a second part that can be moved relative to a first part. A rotary spindle driven by a drive unit provides the movement of the two parts relative to each other. The spindle has one or more threaded areas and additional end stops in the end area of the thread to limit the movement. Furthermore, a first and a second spindle nut are mounted on the spindle, with a thread of the spindle nuts corresponding to an assigned thread range of the spindle. To enable movement of the particular spindle nut, the first or second spindle nut is at least temporarily mounted in a twist-proof fashion relative to the spindle. If, moreover, one of the spindle nuts is permanently mounted in a twist-proof fashion, each rotation of the spindle causes a movement of the spindle nut along the spindle. A seat height adjustment device using the spindle and both spindle nuts permits a particularly compact, space-saving structure.

One object of the present invention is to provide an improved structure for a motor vehicle seat of the type described above, that provides increased occupant protection.

Another object of the invention is to provide such a seat structure that limits deformation movements of the motor vehicle seat in the event of a collision.

These and other objects and advantages are achieved by the seat structure according to the invention, in which a seat height adjustment device adjusts a first part of the motor vehicle seat in relation to a second part of the motor vehicle seat by arranging at least one crash element between the first and second parts of the motor vehicle seat. In the event of a collision, the crash element prevents or at least hinders movement of the first part relative to the second part.

According to the invention, the crash element is embodied as a piston-cylinder unit for this purpose, with the piston being connected to the first part and the cylinder to the second part of the motor vehicle seat, or vice versa. To prevent or at least hinder relative movement of the first part relative to the second part of the motor vehicle seat in the event of a collision, a cylinder wall of the crash element is provided with an opening through which a toothed blocking element of a blocking device can be engaged in a blocking manner with a toothing formed on the piston, at least in the event of a collision.

The seat structure according to the invention therefore prevents a dangerous seat position during a collision and thus keeps head, breast, pelvis and knee values of the vehicle occupants within a limit range in which the risk of injuries can be reduced. At the same time the crash element according to the invention holds the motor vehicle seat (and therefore the person seated and strapped to it) in a favourable position relative to safety devices, such as an airbag, and vehicle safety. Protection of the occupants, can accordingly be increased by the invention. Furthermore, the invention assures that the both parts of the motor vehicle seat are fixed relative to each other during a vehicle collision, and thus eliminates the need for expensive and costly seat reinforcing to perform the same function.

According to an advantageous embodiment of the invention, the mounting point of the cylinder (or of the piston) on the first part of the motor vehicle seat is also a mounting point for a belt buckle. This has the advantage that the force that acts during a vehicle collision on a vehicle occupant (and thus on the safety belt or belt buckle) is directed into the crash element at the same time. The line of force in this case runs almost parallel to the tension/compression direction of the piston and is therefore particularly favourable, without lateral forces being introduced in the crash element. Articulated mounting of the crash element on both the first part of the seat and on the second part of the seat also reinforces this effect, because in this case, similar to a pendulum support, no moments can be introduced into the crash element.

Advantageously, a collision sensor or a pre-collision sensor is provided to move the blocking element to its blocking position in the event of a collision or a pre-collision. Collision sensors of this kind detect an accident directly when the collision occurs or, if designed as pre-collision sensors, immediately before the actual vehicle collision. This offers the possibility of activating the blocking device in good time, which means that vehicle safety and particularly the protection of the occupants can be increased.

According to a preferred embodiment of the invention, the actuation of the blocking element (and thus the blocking of the blocking device) takes place mechanically, pyrotechnically, electrically or electromagnetically. This wide range of design possibilities for the blocking element actuation associated with the invention thus achieves practical applicability, and a high degree of flexibility.

According to a further embodiment of the invention, at least one locking element can be triggered to fix the blocking element in its blocking position. The locking element thus prevents disengagement of the blocking element and ensures permanent blocking of the crash element. By means of the locking element (for example a spring-loaded locking pin), unintentional movement of the blocking element to its non-blocking position is prevented.

Other objects, advantages and novel features of the present invention will become apparent from the following detailed description of the invention when considered in conjunction with the accompanying drawings.

### BRIEF DESCRIPTION OF THE DRAWINGS

A preferred exemplary embodiment of the invention is shown in the drawing and is described in more detail in the following.

The single FIGURE shows a side view of a crash element according to the invention.

### DETAILED DESCRIPTION OF THE DRAWINGS

The FIGURE shows a first part 2 and a second part 3 of the motor vehicle seat 1, which are connected by a crash element 4. The first part 2 may be formed, for example, as the frame of a seat surface, while the second part 3 may, for example, form part of a guide on the floor. The height of the motor vehicle seat 1 can be adjusted by means of a seat height adjustment device (not illustrated), by which the first part 2 of the motor vehicle seat 1 is moved relative to the second part 3 of the motor vehicle seat 1. In the event of a collision, the crash element 4, which is arranged between the first and second parts 2,3 of the motor vehicle seat, prevents or at least hinders movement of the first part 2 relative to the second part 3.

As shown in the FIGURE, the crash element 4 is designed as a piston-cylinder unit, with the piston 5 being connected to the first part 2 of the motor vehicle seat 1 and the cylinder 6 connected to the second part 3. The piston 5 of the crash element 4 is connected to the first part 2 of the motor vehicle seat 1 in such a way that, during an adjustment of the seat height, it is forcibly moved in its tension/compression direction 15, almost without resistance.

While the piston 5 or cylinder 6 of the piston-cylinder unit may have an essentially round cross-section, other cross-section shapes (for example, angular, especially of rectangular cross-section) are also possible. The piston-cylinder unit is thus not restricted to the conventional piston and cylinder of round cross-section, but instead serves merely as a description of a telescopic crash element 4. The piston-cylinder unit according to the invention furthermore provides reliable guidance in its tension/compression direction 15, which means that additional guide elements, such as for example would be necessary in just the tensile direction of stable crash elements, can be omitted.

An opening 8 is provided in a wall 7 of the cylinder 6 through which, at least in the event of a collision, a toothed blocking element 9 of a blocking device 10 can be engaged in a blocking manner with a toothing 11 formed on the piston 5, by adjusting in an adjustment direction 16. The piston 5 is then supported on the cylinder 6 by the blocking element 9. Due to the engagement in a blocking manner, movement of the first part 2 of the motor vehicle seat 1 relative to the second part 3 of the motor vehicle seat 1 is prevented or at least hindered so that a dangerous movement of the seat during a crash is prevented and an associated high risk of injury can be thus be reduced.

As shown in the FIGURE, the cylinder 6 is rotatably attached to either the first part 2 or the second part 3 (shown as the second part 3) of the motor vehicle seat 1, at a mounting point 12 of the cylinder 6. This mounting of the cylinder 6 on a part 2, 3 of the motor vehicle seat 1 can moreover be by means of suitable mounting elements (not illustrated) such as screw-type elements. The rotatable mounting of the crash element 4 at both ends to both parts 2 and 3 of the motor vehicle seat 1 ensures the mounting of the crash element 4 as a pendulum support, thus preventing moments being introduced into the crash element 4. This also means that a force line acting on the crash element 4 runs essentially parallel to the tension/compression direction 15.

Advantageously, the mounting point 12 of the piston 5 or of the cylinder 6 (the piston 5 in the FIGURE), on the first part 2 of the motor vehicle seat 1 is at the same time a mounting point 12′ for a belt buckle 13. This particularly advantageous arrangement improves force introduction through the belt buckle 13 directly into the crash element 4, without the forces having to be diverted beforehand (and further unfavorable stresses thus produced). Furthermore, use of the same mounting point 12′ both for connecting the belt buckle 13 to the first part 2 of the motor vehicle seat 1 and also for connecting the piston 5 to the first part 2 of the motor vehicle seat 1, reduces production time or cost.

According to the FIGURE, the blocking device 10 is arranged on an outer side of the cylinder 6. However, it is also possible from the blocking device 10 on one side of the cylinder 6 or for two blocking devices 10 to be arranged opposite each other on the outside.

The blocking element 9 can be moved to its blocking position mechanically (e.g., by means of a self-locking friction clutch), pyrotechnically (for example, by a firing capsule), electrically (for example, by an electrical servo drive), or electromagnetically (for example, by electromagnets). To achieve the earliest possible blocking movement of the blocking element 9 along its blocking direction 16, thus blocking the blocking device 10, a collision sensor (not illustrated) can be provided to move the blocking element 9 to its blocking position in the event of a collision. Alternatively, a pre-collision sensor can also be provided that moves the blocking element 9 to its blocking position immediately before a collision.

Alternatively, the blocking element 9 may be permanently disposed in its blocking position, and moved to its non-blocking position counter to the blocking direction 16 only by an adjustment of the seat height. This has the advantage that the blocking element 9 (and thus the crash element 4) always prevents or hinders a movement of the first part 2 relative to the second part 3 of the motor vehicle seat 1 and permits it only during a desired seat height setting. This allows collision sensors or pre-collision sensors to be omitted, achieving additional cost advantages. At the same time, this embodiment offers increased vehicle safety because failure in the event of a collision can be prevented.

According to another feature of the invention, at least one locking element 14 may be provided to fix the blocking element 9 in its blocking position when triggered. A locking element 14 of this kind can, for example, be a spring-loaded locking pin that moves in between a wall of the blocking device 10 and a blocking element 9, thus preventing movement of the blocking element 9 counter to the blocking direction, after a blocking movement of the blocking element 9 to its blocking position 16. A locking element of this kind is particularly advantageous if in the event of a collision the piston 5 transmits, due to its force acting in a tension direction 15, a resetting force through the toothing 11 that acts on the blocking element 9. Alternatively, such transmission of a resetting force to the blocking element 9 can be prevented by a special embodiment of the toothing 11, for example as saw-tooth toothing. With an embodiment as a saw-toothed toothing, the piston 5 does not transmit forces transversely to it in the blocking direction 16 to the blocking element 9 due to a force acting in the tension direction 16.

It is also possible for the crash element 4 to enable movement in the compression direction, while preventing movement in the tension direction 15. Furthermore, an actuating device could be provided that moves the motor vehicle seat 1 to a lowered position and thus creates increased headroom, in the event of a collision or pre-collision, including with the crash element 4 activated.

To summarize, the essential features of the solution in accordance with the invention can be characterized as follows.

The invention provides a crash element 4 that is arranged between a first and second parts 2, 3 of a motor vehicle seat and that in the event of a collision prevents or at least hinders relative movement of the two parts 2 and 3. The crash element 4 is in this case designed as a piston-cylinder unit with the piston 5 being connected to the first part 2, and the cylinder 6 with the second part 3, of the motor vehicle seat 1. To block the crash element 4 at least in the event of a collision, an opening 8 is provided in a cylinder wall 7, through which a toothed blocking element 9 of a blocking device 10 can be engaged in a blocking manner with a toothing 11 formed on the piston 5, at least in the event of a collision.

The device according to the invention holds vehicle occupants strapped to the motor vehicle seat 1 in a favorable position in the event of a collision, and thus reduces the risk of injury. At the same time, there is no need for an expensive and costly seat reinforcement, that would fulfil the same function with respect to the blocking movement in the event of a collision, so that cost advantages can be realized.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1.-8. (canceled)

9. A motor vehicle seat comprising:
a seat height adjustment device configured to adjust a first part of the motor vehicle seat in relation to a second part of the motor vehicle seat; and
at least one crash element that is disposed between said first and second parts of the motor vehicle seat, and at least impedes movement of the first part relative to the second part in the event of a collision; wherein,
the crash element comprises a piston-cylinder unit, the piston being connected to the first part of the motor vehicle seat and the cylinder being connected to the second part of the motor vehicle seat; and
an opening is provided in a cylinder wall of the cylinder, through which a toothed blocking element of a blocking device can be engaged in a blocking manner with a toothing formed on the piston, at least in the event of a collision.

10. The motor vehicle seat as claimed in claim 9, wherein the cylinder is rotatably mounted on the motor vehicle seat via a mounting point formed on the cylinder.

11. The motor vehicle seat as claimed in claim 9, wherein the mounting point of the piston on the first part of the motor vehicle seat is at the same time a mounting point for a belt buckle.

12. The motor vehicle seat as claimed in claim 9, wherein the blocking device is arranged on the outside of the cylinder.

13. The motor vehicle seat as claimed in claim 9, wherein the blocking element is actuated mechanically, pyrotechnically, electrically or electromagnetically.

14. The motor vehicle seat as claimed in claim 9, further comprising a collision sensor or pre-collision sensor is provided to move the blocking element to its blocking position in the vent of a collision or a pre-collision.

15. The motor vehicle seat as claimed in claim 9, wherein:
the blocking element is permanently in its blocking position; and
the blocking element moves to a non-blocking position only in the event of a seat height adjustment.

16. The motor vehicle seat as claimed in claim 9, further comprising at least one locking element that is triggerable to fix the blocking element in its blocking position.

17. A height adjustment device for a motor vehicle seat having first and second parts which are movable relative to each other, said height adjustment device comprising:
at least one crash element that is disposed between said first and second parts of the motor vehicle seat, and at least impedes movement of the first part relative to the second part in the event of a collision; wherein,
the crash element comprises a piston-cylinder unit, the piston being connected to the first part of the motor vehicle seat and the cylinder being connected to the second part of the motor vehicle seat; and
an opening is provided in a cylinder wall of the cylinder, through which a toothed blocking element of a blocking device can be engaged in a blocking manner with a toothing formed on the piston, at least in the event of a collision.

18. The height adjustment device according to claim 17, wherein:
said first part is mountable to a floor of the vehicle; and
said second part is mountable to a cushion of said vehicle seat.

19. The height adjustment device according to claim 17, wherein:
said second part is mountable to a floor of the vehicle; and
said first part is mountable to a cushion of said vehicle seat.

20. The height adjustment device according to claim 18, wherein a mounting point of the second vehicle part also forms a mounting point for a vehicle seat belt.

21. The height adjustment device according to claim 19, wherein a mounting point of the first vehicle part also forms a mounting point for a vehicle seat belt.
